(19) United States
(12) Patent Application Publication
(10) Pub. No.: US 2026/0210458 A1
(43) Pub. Date: Jul. 23, 2026

(54) IMPROVED TUBES AND HOSES DISPLAYING INFORMATION

(71) Applicant: Danfoss A/S, Nordborg (DK)

(72) Inventors: Recep Can, Tekirdag (TR); Veysel Aktemur, Tekirdag (TR); Ayberk Orlak, Çerkezköy (TR); Rajat Haldar, Mathura (IN); Hermant Sonawane, Pune (IN)

(21) Appl. No.: 19/139,974

(22) PCT Filed: Nov. 16, 2023
(86) PCT No.: PCT/EP2023/082055

§ 371 Date: Jun. 17, 2025

(30) Foreign Application Priority Data
Dec. 20, 2022 (IN) 202211073903

(51) Int. Cl. F16L 11/12; F16L 9/12; F16L 11/08

(52) U.S. Cl. CPC F16L 11/124; F16L 9/121; F16L 11/083; F16L 2201/60

(57) ABSTRACT

The disclosure relates a tube or a hose (1, 13), including an elongated inner void that is enclosed by a mantle (4, 17) in a radial direction. At least one information carrier device (9, 10, 19) is provided, wherein the information that is stored on the information carrier device (9, 10, 19) can be read in a contactless way. The at least one information carrier device (9, 10, 19) is embedded inside the mantle (4, 17).

### CROSS-REFERENCE TO RELATED APPLICATIONS

This application is a National Stage application of International Patent Application No. PCT/EP2023/082055, filed on Nov. 16, 2023, which claims priority to Indian Patent Application No. 202211073903, filed on Dec. 20, 2022, each of which is hereby incorporated by reference in its entirety.

### TECHNICAL FIELD

The invention relates to an elongated fluid conduit device, comprising an elongated inner void that is enclosed by a mantle in a radial direction, that comprises at least one information carrier device. In particular, the elongated fluid conduit device can be a tube or a hose. The invention further relates to a method of producing an elongated fluid conduit device, in particular of an elongated fluid conduit device of the aforementioned type.

### BACKGROUND

Elongated fluid conduit devices like tubes or hoses are used in an extremely wide area of technical fields for a plethora of different purposes. Just to name some examples: such elongated fluid conduit devices are used for transferring water, air, technical gases, hydraulic fluid and sometimes even for transporting solids (where the solids can be transported under the influence of gravity and/or by flowing them along together with a fluid). In the present context, fluid may relate to a liquid and/or a gas (including a mixture of gas and liquid), and also to a fluid, where no distinction between gas and liquid can be made any more. Furthermore, the fluid may contain solid particles to certain extent, as well.

However, not only the type of fluid (including solids) can vary wildly, but also their temperatures and/or their pressure levels. Just to name some examples for different pressure levels: a hose for transporting air can be the hose of a vacuum cleaner where the pressure level inside the tube is even lower than the surrounding pressure level (perhaps some 0.7 bars inside of the tube and 1 bar outside of the tube). However, if pressurised air from a pressurised gas bottle is transferred, the respective pressure levels are easily around 200 bars, 300 bars or even 500 bars. An example for such a hose would is the hose connecting the pressurised air tank of a scuba-diving equipment to it's pressure gauge.

Similarly to gases, the pressure level of fluids (liquids) that are transported by a tube or hose can vary wildly as well. As an example, the tube connecting the diesel tank and the fuel injection pump of a diesel vehicle transfers diesel fuel at a pressure level that is about the same as the surroundings (i.e. about 1 bar). However, the tube connecting the fuel injection pump and the injection nozzle of the diesel engine may easily have to withstand a pressure level of 3000 bars or the like in modern, common rail injection diesel engines.

Irrespective of the pressures and the temperatures involved, further adaptions of the elongated fluid conduit device have to be made in dependence of the chemical behaviour of the fluid to be transferred and/or of the ambient surroundings, the elongated fluid conduit devices are to be used in. This does not only relate to the elongated fluid conduit device being able to withstand the respective chemicals without deterioration, but also with respect to its permeability/amount of diffusion with respect to the substances involved.

Therefore, it is no surprise that an almost indefinite variation of different elongated fluid conduit devices were around, are around and will be around in the future on the market. In particular they can differ with respect to inner diameter, outer diameter, the material(s) of the elongated fluid conduit device, their elasticity, the number of cycles a hose may be bent, resistivity against mechanical and/or chemical were, resistivity against temperatures (in particular low and high temperatures), resistivity against ageing, suitability for various substances to be transported and/or environments to be used in, impermeability for certain substances, pressure resistance, and the like.

All this information has to be available to the customer of the elongated fluid conduit device (which may be a manufacturer as well, for example a car manufacturer, a manufacturer of hydraulic equipment, a manufacturer of tractors, excavators, or the like).

However, preferably even more information should be available to the manufacturer and even later to personal (for example personal performing maintenance or repairs), for example with regard to a batch number, the production time, the producing company and so on.

Even further, with increasing environmental and recycling concerns, the availability of such information is even required at the end of the life cycle of the elongated fluid conduit device, so that a recycling company is able to determine whether the tube or hose may be reused and, in case a reuse is not possible or sensible any more, how to recycle the elongated fluid conduit device and/or how to properly dispose the elongated fluid conduit device.

The task of providing the customer or the respective person in question with such information is of course not new, and therefore a variety of marking methods and types of information carriers have already been proposed.

A very straightforward possibility is the use of paper tags that are attached to the elongated fluid conduit device by the manufacturer of the elongated fluid conduit device. A disadvantage is, however, that such tags will usually be removed by the first customer of the elongated fluid conduit device and will therefore not be available to a person at a later point in time any more. As an example: a coil of a fluid hose will be delivered to a car manufacturer. The tag is available and may be used for storing purposes and for checking the correctness of the type of hose at the installation site. However, the tags will usually be removed before installation of the tube or hose. It is to be noted that another intrinsic problem is involved with such tags, since typically a coil of hose that is provided to the first customer is regularly cut into shorter pieces of tubes and hoses, where only such shorter pieces of tubes and hoses will be installed in a car or the like.

A possible way to deal with these problems is to print the required information onto the outside of the mantle of the elongated fluid conduit device, in particular at regular intervals (so that even shorter sections of the respective tube or hose will contain the required information). A disadvantage with this approach is the usually only limited availability of area, which may be dealt with by using barcodes, part numbers, QR codes or the like. However, there is still a problem in that the information may become unreadable or even eraded with time due to mechanical abrasion, agglomerating stains and the like.

### SUMMARY

It is therefore an object of the present invention to suggest an elongated fluid conduit device, in particular a tube or hose, that that is improved over elongated fluid conduit devices that are available in the state of the art.

It is another object of the invention to propose a method of producing an elongated fluid conduit device, in particular of a tube or a hose, that is improved over methods of producing an elongated fluid conduit device that are known in the prior art.

It is suggested to design an elongated fluid conduit device that comprises an elongated inner void that is enclosed by a mantle in the radial direction, and that further comprises at least one information carrier device, wherein the information that is stored on the information carrier device can be read in a contactless way, in a way that the at least one information carrier device is embedded inside the mantle. In particular, the elongated fluid conduit device can be a tube or a hose. “Elongated” in the context of an “elongated fluid conduit device” usually means that the respective device (and correspondingly the respective inner void) has a substantive extent in an axial direction. In particular, the extent in the axial direction is usually significantly larger than it is in the radial/circumferential direction. It is to be noted that the cross section (in particular a crosscut normal to the axial direction) may show essentially any shape. However, for pressure resistance reasons, typically a somewhat roundish/rounded cross-section is preferred on the inner and/or outer surface side of the mantle. In particular, a circumferential, an ellipsoidal or a similar cross section may be envisioned. However, depending on the particular application, different cross-sectional shapes may be sensible as well, for example, triangular, rectangular (in particular quadratic), or general polygonal shapes (in particular with 5, 6, 7, 8, 9, 10 or even more edges) may be envisaged. The corners may be (at least to a certain extent and/or a certain percentage) sharp corners and/or rounded corners. This may relate to the inside and/or to the outside shape of the elongated fluid conduit device. It is to be noted that it is possible that on the inside and/or on the outside of the elongated fluid conducting device additional (separating) walls, fins, protrusions, recesses or the like may be present. As an example, a separation wall may be placed inside the void of a circularly shaped hose (diagonal wall through the central axis) that divides the inner void of the elongated fluid conduit device into two fluidly separated fluid chambers. Also, it is possible that the cross-sectional shape, the presence, shape and/or size of inner/outer fins, walls, protrusions or recesses may change along the axial direction of the elongated fluid conduit device. As an example, a cross-sectional shape may be followed by a quadratic cross-sectional shape. By saying that the elongated inner void is enclosed by a mantle in the radial direction, this means that when seen from the centre line/centre point towards the outside, the inner void will be followed by the mantle, while the mantle is followed by the outside area. This statement is usual true for (essentially) all directions emanating from the centre point/axis. However, is does not exclude the possibility that the mantle shows certain openings at certain points for whatever reason. As an example, openings in the form of bores may be provided for attachment of branching sideline tubes/hoses, for attachment of measurement equipment or the like. In other words, the mantle may be seen as a circumferential enclosure of the elongated inner void alternatively or additionally. How the information may be retrieved in a contactless way is essentially arbitrary. In particular, optical readouts, electromagnetic readouts, inductive readouts, acoustic readouts or the like may be envisioned. According to the present disclosure, the at least one information carrier is embedded inside the mantle. This embedding may be realised in a way that the section of the mantle, where the at least one information carrier device is embedded forms an essentially smooth surface and/or forms a surface without (a significant) protrusion and/or recess. While it is possible that one surface side (or even more surface sides) of the information carrier device are visible/reachable from the outside (i.e. from the inner void and/or from the outside of the elongated fluid conduit device), it is preferred if the information carrier device is (essentially) fully encapsulated inside the mantle. This way, the information carrier device is particularly well protected and therefore the possibility of a damage of the information carrier device and/or of the information that is contained in the information carrier device is reduced, typically significantly reduced. This way the possibility of a successful readout is typically possible even after weeks, months or years after the elongated fluid conduit device was produced and/or arranged in its respective surroundings. It is needless to say that this is a significant advantage. Nevertheless, due to the contactless readout possibility of the information carrier device, despite of the embedding of the information carrier device inside the mantle, a readout is still easily possible. In particular, a significant protection for the information carrier device can be realised with respect to aggressive chemicals and/or environments, temperature influences (in particular short time temperature peaks or ditches), electric shortages due to electrically conductive fluids, corrosion of the information carrier device, protection against mechanical wear, and the like.

While different designs are possible, it is usually preferred if the at least one information carrier device comprises at least an electronic chip and/or at least an antenna device. In particular it is suggested that the information carrier device comprises a RFID tag. Additionally or alternatively, it is suggested that the information carrier device is an externally powered device. Usage of electronic chips, antenna devices (in particular in the form of wound coils or printed circuit pattern coils are easily, readily and economically available in the market, even in large numbers. Therefore, an elongated fluid conduit device according to the present embodiment can be introduced into the market fastly and in huge numbers. In particular, so-called RFID tags (Radio Frequency IDentification tags) are cheaply and readily available in the market, even in large numbers. Such RFID tags are particularly suitable for the presently proposed purpose. In particular, they can be read out (and possibly even written with information) in a contactless way using external devices that are also relatively inexpensively available. RFID tag is a technology that has proven to be very reliable as well. Furthermore, RFID tags can easily store sufficient information (memory size) for the presently proposed purpose of an information carrier device of an elongated fluid conduit device. Using externally powered devices as information carrier devices is particularly advantageous since this way no (expensive) batteries are needed. Also, internal batteries do always have a limited lifetime, limiting the temporal usability of the presently proposed elongated fluid conduit devices. Powering the information carrier device externally (for example by electromagnetically/inductively introducing power (electrical power) into the information carrier device, so that the information carrier device can be read out and/or written), the lifetime of the elongated fluid conduit device may be essentially unlimited. This is of course highly advantageous. Furthermore, it should be noted that this way the content of precarious materials inside the elongated fluid conduit device can be reduced as well. This may not only increase the acceptance of the presently proposed elongated fluid conduit device, but it also makes recycling and/or proper disposal of the elongated fluid conduit device at the end of its lifespan easier and less costly. It is to be noted that presently proposed RFID tags (but also other devices) are such externally powered devices.

Furthermore, it is suggested that the mantle comprises at least two adjacent sections, wherein the at least one information carrier device is arranged in the interfacing section between the at least two adjacent sections. In particular, the sections may be placed along a radial direction of the elongated fluid conduit device. Therefore, they may form (radially) adjacent sheeths, in particular an inner sheath and an outer sheath. This may be interpreted in a way that the mantle of the elongated fluid conduit device shows a (radially) inner mantle part and a (radially) outer mantle part (section/sheath). It is possible that even more sections are provided and/or that a (at least one) certain reinforcement device and/or a certain adhesive and/or a certain coating is provided on at least one (part of the) surface of at least one of the two adjacent sections. Preferably, such an additional means may be placed between the at least two sections (where these sections are still to be considered as being adjacent). Furthermore, it is to be noted that in the area, where the information carrier device is located, the two adjacent sections usually do not contact each other directly; nevertheless, they may still be considered as being adjacent sections in the context of the present disclosure. The at least two sections of the mantle may show an essentially similar or even (essentially) identical thickness. However, it is also possible that the thicknesses of the at least two adjacent sections (and/or possibly more sections, coatings etc.) may show a significantly different thickness. In any case, using the presently proposed design, the manufacture of the elongated fluid conduit device may be particularly simple and cost efficient. Furthermore, the at least one information carrier device may be particularly well protected as well.

Furthermore, it is suggested that the mantle comprises at least one reinforcement, wherein the reinforcement preferably comprises at least a fabric (woven fabric/crimped fabric) and/or at least a non-crimped fabric and/or at least a reinforcement wire and/or at least a reinforcement thread. Using such a reinforcement, the mechanical stability of the resulting elongated fluid conduit device can be particularly high. When talking about a “reinforcement wire”, in particular a metallic wire may be meant. When talking about a “reinforcement thread”, in particular a thread consisting essentially of a non-metallic material may be meant (for example para-aramid, nylon or the like). It is to be noted that the reinforcement, in particular a non-crimped fabric and/or a woven fabric may comprise (essentially metallic) wires and/or (essentially non-metallic) threads. In particular, the reinforcement may be arranged between different sections of the mantle, in particular between the interfacing area of the aforementioned at least two adjacent sections of the mantle. This way, the manufacturing process can be particularly simple and therefore particularly cost efficient. Furthermore, the reinforcement will usually be particularly well protected against influences from the outside as well.

Yet further, the elongated fluid conduit device may be designed in a way that a plurality of information carrier devices is used. Preferably, the plurality of information carrier devices are arranged in an axial direction of the elongated fluid conduit device. Furthermore, preferably the plurality of information carrier devices are arranged in a linear and/or in a helical way and/or arranged at essentially equally spaced intervals. By the notion “arranged in an axial direction” it is meant that a certain distance in the axial direction is present between two consecutive information carrier devices. This does not exclude the possibility of an additional tangential and/or radial offset or the like. This way, it is not problematic if a elongated fluid conduit device is cut into several pieces. If the individual pieces are not too short, the respective pieces will still contain at least one information carrier device with the consequence that the relevant information is still present, for example for a recycling or a disposal plant when the machinery, the elongated fluid conduit device is used in, finally came to the end of its lifetime. The distance between two consecutive information carrier devices has to be chosen in a way that, depending on the purpose the elongated fluid conduit device is used for, the shortest section of an elongated fluid conduit device that will be cut off from a coil that is delivered from the producing plant of the elongated fluid conduit device will contain at least one (working/undamaged) information carrier device with a sufficiently high probability for realistic scenarios. It is to be noted that cutting off a piece of hose/tube may result in cutting through an information carrier device, and thus destroying the respective information carrier device. It is further to be noted that the presence of two or more (operative) information carrier devices within one cut-off piece of the elongated fluid conduit device does not pose a problem from a technical side. However, for cost efficiency reasons, the number of information carrier devices should not be excessive either. For realistic scenarios, information carrier devices at distance intervals between 0 cm, 1 cm, 2 cm, 3 cm, 4 cm, 5 cm, 7.5 cm, 10 cm, 15 cm, 20 cm and 25 cm (lower limit) and 1 cm, 2 cm, 3 cm, 4 cm, 5 cm, 7.5 cm, 10 cm, 15 cm, 20 cm, 25 cm, 30 cm, 40 cm, 50 cm, 60 cm, 70 cm, 80 cm, 90 cm and 1 m (upper limit) are usually preferred. In particular in case the plurality of information carrier devices are arranged in a helical way, the angle enclosing the axial direction of the elongated fluid conduit device and the linear extent of the arrangement of information carrier devices may be between 5°, 10°, 15°, 20°, 25°, 30°, 35°, 40°, 45°, 50° or 55° (lower limit) and 10°, 15°, 20°, 25°, 30°, 35°, 40°, 45°, 50°, 55° or 60° (upper limit).

Yet further, it is proposed that the plurality of information carrier devices are interconnected with each other. While the interconnection may be realised only in mechanical way, it is possible that the plurality of information carrier devices are interconnected in an electrically conductive way and/or in a way enabling a communication between the plurality of information carriers. In particular, such a communication can be realised by electrical conductors (wires), but also in an optical way and/or an electromagnetic way (for example by a communication between two RFID tags using radio frequency transmissions). Even in case of a purely mechanical connection between information carrier devices, this can be advantageous from a mechanical perspective, in particular with respect to placing the information carrier devices on a preform of the elongated fluid conduit device and thus with respect to producing the elongated fluid conduit device. In particular, it is usually easier to place the respective information carrier devices onto/into a mantle/section of the mantle, or the like. In case a communication between information carrier devices is possible, information between the information carrier devices can be exchanged, for example if a certain type of information is not present (anymore) in one particular information carrier device, while it is still present in another information carrier device. Furthermore, this way, the elongated fluid conduit device may sort of “autodetect” that it was cut into pieces; this information may be used for purposes of calculating a wear, remaining lifetime, or the like.

Furthermore, it is suggested that the mantle comprises at least an extruded section, in particular an extruded covering section. This way, the production of the elongated fluid conduit device can be realised particularly simple, effective and cost-efficient. In particular a good sealing of the at least one information carrier device from the exterior (and possibly aggressive surroundings) can be realised very easily and efficiently. Furthermore, extrusion is a process that is widely around in the prior art and is well understood. Therefore, appropriate tools can be easily bought and adapted, even for the presently suggested elongated fluid conduit device.

Yet further, it is suggested that at least one information carrier device is a read-only device and/or a bidirectionally operatable device and/or a write-once-read-many device. The type of device may be chosen according to the presently intended use of the elongated fluid conduit device. When talking about a “bidirectionally operatable device”, this is usually to be understood that a plurality of write operations may be performed (where of course the written information may be read afterwards, and possibly may be erased or overwritten later on). It is to be noted that for cost efficiency reasons, different types of information carrier devices may be used. As an example, one bidirectionally operatable device may be followed by one or a plurality of read-only information carrier devices (for example 1, 2, 3, 4, 5 or more), and then followed by another bidirectionally operatable device. The aspect of different information carrier devices is, however, also applicable for different aspects of the information carrier devices (for example a different memory size, a different readout possibility and the like).

Another possible embodiment for an elongated fluid conduit device can be realised if the at least one information carrier device comprises a secure communication ability with an authorised server. This way, the security and reliability of the elongated fluid conduit device can be significantly increased. As an example, the secure communication can be realised in a way that using cryptographic means, a counterfeiting of elongated fluid conduit devices may be very hard to do, therefore making product counterfeiting significantly more complicated. It is to be noted that the presence of presently proposed information carrier devices as such (i.e. without cryptographic safety measures or the like) does pose a certain additional burden against counterfeiting. Furthermore, using a secure communication may be particularly advantageous for writing operations onto the information carrier device. This way, it can be ensured that only authorised personnel may write information onto the at least one information carrier device. Therefore, changing the production time and/or information about servicing events in an incorrect way or the like can be hindered, thus increasing product safety accordingly.

Even further, it is proposed to design the elongated fluid conduit device in a way that the at least one information carrier device is designed and arranged in a way that it comprises at least one information, taken from the group comprising: information about the material of the elongated fluid conduit devices; manufacturing date; producing factory; producing machine; batch number; specific information of the elongated fluid conduit device; information about servicing/overhauls; product type; pressure resistance. Using these information, legal requirements and/or desires by the customers can be efficiently satisfied.

Yet further, a method of producing an elongated fluid conduit device is proposed, in which a first sheath of a mantle is formed, an information carrier device is attached to the first sheath of the mantle, and a second sheath is applied onto the first sheath comprising the at least one information carrier device. The design, design ideas and/or modifications of the respective parts may be used according to the previous and following disclosure, in particular at least in analogy. In particular, the elongated fluid conduit device may be an elongated fluid conduit device according to the preamble of claim 1 (in particular of the preamble of claim 1 as originally filed) or may be an elongated fluid conduit device according to the previous disclosure. In particular, the elongated fluid conduit device may be an elongated fluid conduit device according to the previous disclosure. The presently proposed method is particularly suitable for such elongated fluid conduit devices. In particular, the respective method will yield a simple and cost-efficient method of producing such an elongated fluid conduit device.

In particular, the method may be performed in a way that at least one of the sheaths is manufactured using a method, taken from the group comprising: extrusion techniques; spreading techniques; application techniques using a spreading knife; application of an elongated strip, in particular in a helical way. In particular the application of an elongated strip may not only relate to at least one sheath of the mantle, but also to an arrangement (band) comprising at least one information carrier device.

### BRIEF DESCRIPTION OF THE DRAWINGS

Further advantages, features, and objects of the invention will be apparent from the following detailed description of the invention in conjunction with the associated drawings, wherein the drawings show:

FIG. 1: the manufacture and the design of a first embodiment of an elongated fluid conduit device according to the present disclosure in different views;

FIG. 2: the manufacture and the design of a second embodiment of an elongated fluid conduit device according to the present disclosure in different views;

FIG. 3: a possible design of an information carrier device for an elongated fluid conduit according to the present disclosure in a schematic top view;

FIG. 4: a possible way of retrieving information from an embodiment of an elongated fluid conduit device according to the present disclosure in a schematic view.

### DETAILED DESCRIPTION

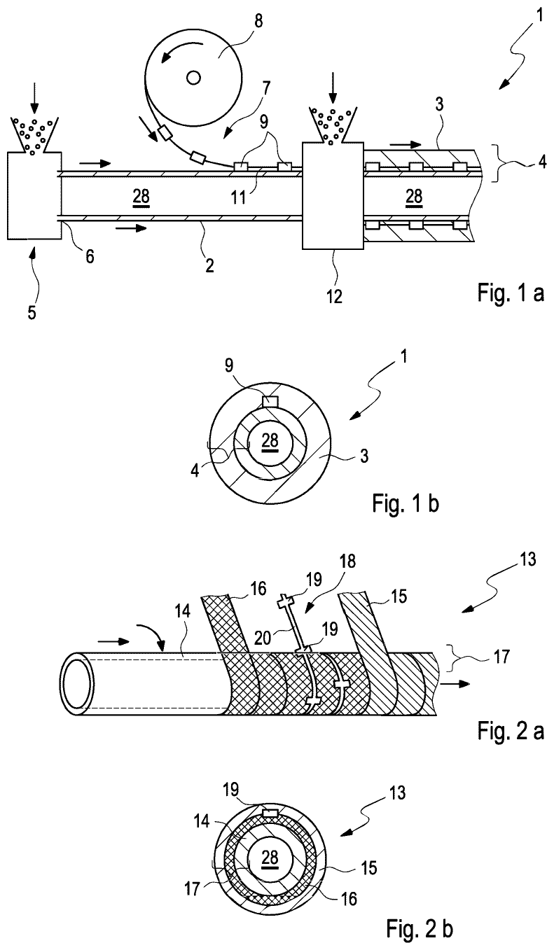

FIG. 1 shows a first possible embodiment of an elongated fluid conduit device according to the present disclosure that is presently designed as a flexible fluid hose 1. FIG. 1a shows the flexible fluid hose 1 in a schematic cross section (right side of FIG. 1a), together with a schematic drawing on how to produce such a flexible fluid hose 1 (left side of FIG. 1a). For clarification, FIG. 1b shows a schematic cross section of the flexible fluid hose 1 of FIG. 1a.

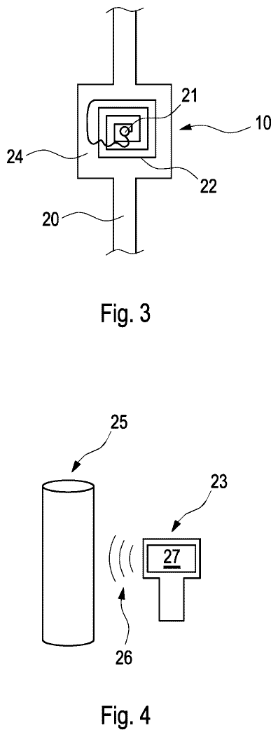

As can be seen in FIG. 1a on the left side, a first, inner sheath 2 (or inner section 2) of the mantle 4 of the flexible fluid hose 1 is produced using an extruding device 5 that is in known in the state of the art, as such. As an example, the extruding device 5 uses granular raisin material (indicated by circles and a feeding hopper) that is melted and pushed out of an extruding die 6 of the extruding device 5. Thus, a void 28 is formed inside the flexible fluid hose 1. Arrows show the advancing inner sheath 2 out of the extruding die 6 (movement direction to the right side of FIG. 1a). After a certain cooling phase, a band 7 of information carrier devices 9 is fed from a supply reel 8. The band 7 of information carrier devices 9 is attached onto the outer circumferential surface of inner sheath 2. This may be done using an adhesive (where the adhesive may be provided on the band 7 of information carriers 9 prior to being placed onto the inner sheath 2 of the mantle 4. In particular, the band 7 can be designed as a plurality of mechanically interconnected RFID chips 10 (see FIG. 3) that are used as information carrier devices 9. The individual information carrier devices 9 are presently interconnected by an interconnecting wire 11 that may comprise a metal and/or a polymeric material (for example copper, iron (metal) or polyvinylidiene fluoride (PVDF), perfluoralkoxy alkane (PFA) or cross-linked polyethylene (PEX) (polymeric wire)) and/or a silicon substrate.

The thus prepared preform of an inner sheath 2 and a band 7 of information carrier devices 9 attached thereto is consequently fed into a coating device 12, that may be designed as a extruding device as well (similar to the extruding device 5). The coating device 12 applies a second, outer sheath 3 onto the outside of the inner sheath 2, thus creating a coating that encloses the two neighbouring, adjacently arranged inner sheath 2 and outer sheath 3. Inner sheath 2 and outer sheath 3 (together with the band 7 of information carrier devices 9 enclosed therein) form the mantle 4 of the flexible fluid hose 1, the mantle defining the inner void 28.

The arrangement of the inner sheath 2, the outer sheath 3 and the band 7 of information carrier devices 9 can also be seen in the cross-sectional view of FIG. 1b.

FIG. 2 shows another possible embodiment of an elongated fluid conduit device together with a possible way of producing the elongated fluid conduit device in a schematic perspective view (see FIG. 2a). FIG. 2b shows the arrangement of the elongated fluid conduit device in a schematic cross section. The presently shown second possible embodiment of an elongated fluid conduit device is again designed as a flexible fluid hose 13 (see right side of FIG. 2a).

First of all, an inner sheath 14 of a mantle 17 is produced. For this, extrusion techniques, using an extruder (similar to the one used in FIG. 1a) may be used. However, different production techniques may be employed for this task as well.

In a next step, a reinforcement web 16 is arranged onto the inner sheath 14 of the mantle 17. The reinforcement web 16 may be temporarily fixed onto the inner sheath 14 using adhesives, as an example. The reinforcement web 16 may be a woven fabric (crimped fabric) or a non-crimped fabric. The material may comprise threads with a high tensile force (for example nylon threads, para-aramid threads or the like). Also, it is possible to use a mesh made of metal, which is particularly useful in case an electrical shielding is desired in addition to the mechanical reinforcement.

In the presently shown embodiment of manufacturing the flexible fluid hose 13, the reinforcement web 16 is applied as a band that is wound onto the rotating inner sheath 14, forming a helical wrapping on the inner sheath 14.

As a next step (further down the movement direction; see advancing arrow), a band 18 that comprises a plurality of information carrier devices 19 (for example RFID tags 10—see FIG. 3) is attached. The band 18 of information carrier devices 19 is wound onto the reinforcement web 16 in a helical way well (similar to the application of the reinforcement web 16 onto the inner sheath 14). A temporal fixation of the band 18 of information carrier devices 19 may be realised by using adhesives, just to name an example. Presently, the angle between the axial direction of the flexible fluid hose 13 and the direction of the band 18 of information carrier devices 19 has been chosen to be 30°.

As can be seen, the presently used embodiment individual information carrier devices 19 are interconnected by a thin foil 20 with a certain width. In effect, the foil 20 can be a carrier foil 24 that also supports the electric and electronic components 21, 22 of the information carrier device(s) 19. In any case, information carrier devices 19 and interconnecting foils 20 together form the band 18 that is placed onto the reinforcement web 16. In yet another step, a coating layer, forming the outer sheath 15 of the mantle 17 is applied onto the preform of inner sheath 14, reinforcement web 16 and band 18 of information carrier devices 19. Presently, the outer sheath 15 is also applied as a band made of the respective material in a helical way. Reference is made to the afore-described first embodiment of an elongated fluid conduit device.

As a final production step (presently not shown in detail), the mantle 17 can be cured, for example by raising the temperature using a continuous furnace or the like.

The arrangement of the flexible fluid hose 13 can also be seen in the cross-sectional view of FIG. 2b.

FIG. 3 shows a typical design of an RFID tag 10 that may be used in combination with the present disclosure, in particular in combination with a flexible fluid hose 1 according to FIG. 1 and/or with the flexible fluid hose 13 in accordance with FIG. 2. The RFID tag 10 shows an electronic chip 21 on which the information is stored. The electronic chip 21 is passively powered, i.e. it has no battery for providing electrical energy. Instead, an interrogation (see also FIG. 4) comprises two steps, namely a power feeding step, in which the antenna 22 is used for introducing electrical energy into the RFID chip 10. The thus introduced electrical energy is temporarily stored in a capacitor that is provided on the electronic chip 21 (whereas additionally or alternatively an external capacitor can be placed onto the substrate 24 of the RFID tag 10 as well).

The antenna 22 for supplying the RFID tag 10 with electrical energy and for communication with an external interrogation device 23 (see FIG. 5) is presently designed as a printed circuit conduit pattern on top of a carrier substrate 24 that also holds the electronic chip 21 and possibly an additional capacitor; see above). There carrier substrate 24 extends at two opposing sides to form a interconnecting foil 20 that forms a mechanical interconnection with a neighbouring RFID tag 10 (see in particular FIG. 2a). However, instead of a foil 20, an interconnection between neighbouring RFID tags 10 can also be employed using a wire (metal/polymeric wire; different material).

FIG. 4 shows a schematic view for elucidating an interrogation process of an elongated fluid conduit 25 according to the present disclosure (for example a flexible fluid hose 1 and/or a flexible fluid hose 13, according to the embodiments shown in FIG. 1 and FIG. 2, respectively).

A handheld interrogation device 23 is placed in the vicinity of the elongated fluid conduit 25. When a RFID tag 10 (or another information carrier device type) is sufficiently close to the interrogation device 23, a communication 26 (schematically shown by radiation wave 26 in FIG. 5) is initiated and the information that is retrieved from the RFID tag 10 of elongated fluid conduit 25 is presented on an electronic display 27 of the interrogation device 23. It should be noted that the interrogation device 23 can in turn communicate with a computer and/or a computer network (for example the Internet), so that a communication with a central server that is supplied by the original manufacturer of the elongated fluid conduit 25 can be established.

It is to be noted that the communication 26 consists of two phases, typically. Firstly, an electric charging pulse is applied, so that the RFID chip is temporarily charged with electric energy (in particular a capacitor of the RFID chip 21). Then, a wireless communication based on radio signals is established between the RFID tag 10 and the interrogation device 23. The communication can be unidirectional, i.e. information can only be read from the RFID tag 10. However, it is also possible that the interrogation device 23 may be used to transmit and store data onto the RFID tag 10 as well. Furthermore, it should be mentioned that a linear and/or a circular polarisation of the transmission signals are possible, as it is known in the state-of-the-art, as such.

It is to be noted that a single one or a plurality of the features of the presently disclosed detailed embodiment may be used in combination with the generic description of the present disclosure.

While the present disclosure has been illustrated and described with respect to a particular embodiment thereof, it should be appreciated by those of ordinary skill in the art that various modifications to this disclosure may be made without departing from the spirit and scope of the present disclosure.

What is claimed is:

1. An elongated fluid conduit device, in particular tube or hose, comprising an elongated inner void that is enclosed by a mantle in a radial direction, further comprising at least one information carrier device, wherein the information that is stored on the information carrier device can be read in a contactless way, wherein the at least one information carrier device is embedded inside the mantle.

2. The elongated fluid conduit device according to claim 1, wherein at least one information carrier device comprises at least an electronic chip and/or at least an antenna device, and is in particular a RFID tag and/or characterised in that the information carrier device is an externally powered device.

3. The elongated fluid conduit device according to claim 1, wherein the mantle comprises at least two adjacent sections, wherein the at least one information carrier device is arranged in the interfacing section between the at least two adjacent sections.

4. The elongated fluid conduit device according to claim 3, wherein the mantle comprises at least one reinforcement, the reinforcement preferably comprising at least a fabrics and/or at least a non-crimped fabrics and/or at least a reinforcement wire and/or at least a reinforcement thread.

5. The elongated fluid conduit device according to claim 1, wherein a plurality of information carrier devices, wherein the plurality of information carrier devices is preferably arranged in an axial direction of the elongated fluid conduit device, and wherein the plurality of information carrier devices are more preferably arranged in a linear and/or a helical way and/or are arranged at essentially equally spaced intervals.

6. The elongated fluid conduit device according to claim 5, wherein the plurality of information carrier devices are interconnected with each other, in particular in an electrically conductive way and/or in a way enabling a communication between the plurality of information carriers.

7. The elongated fluid conduit device according to claim 1, wherein the mantle comprises at least an extruded section, in particular an extruded covering section .

8. The elongated fluid conduit device according to claim 1, wherein at least one information carrier device is a read-only device and/or a bidirectionally operatable device and/or a write-once read-many device.

9. The elongated fluid conduit device according to claim 1, wherein the at least one information carrier device comprises a secure communication ability with an authorised server.

10. The elongated fluid conduit device according to claim 1, wherein the at least one information carrier is designed and arranged in a way that it comprises at least one information, taken from the group comprising: information about the material of the elongated fluid conduit device; manufacturing date; producing factory; producing machine; batch number; specification information of the elongated fluid conduit device; information about servicing/overhauls; product type; pressure resistance.

11. A method of producing an elongated fluid conduit device, in particular of an elongated fluid conduit device according to the preamble of claim 1, wherein a first sheath of a mantle is formed, and an information carrier device is attached to the first sheath of the mantle, and a second sheath is applied onto the first sheath comprising the at least one information carrier device.

12. The method according to claim 11, wherein in that at least one of the sheaths is manufactured using a method, taken from the group comprising: extrusion techniques; spreading techniques; application techniques using a spreading knife; application of an elongated strip, in particular in a helical way.
